(19) United States
(12) Patent Application Publication
(10) Pub. No.: US 2018/0132042 A1
(43) Pub. Date: May 10, 2018

(54) LASER MICROPHONE UTILIZING MIRRORS HAVING DIFFERENT PROPERTIES

(71) Applicant: VocalZoom Systems Ltd., Yokneam Illit (IL)

(72) Inventors: Tal Fishman, Haifa (IL); Tal Bakish, Modi'in (IL)

(21) Appl. No.: 15/511,076

(22) PCT Filed: Jul. 25, 2016
(86) PCT No.: PCT/IB2016/054415

§ 371 Date: Mar. 14, 2017

Related U.S. Application Data
(60) Provisional application No. 62/197,023, filed on Jul. 26, 2015.
(60) Provisional application No. 62/197,106, filed on Jul. 27, 2015.
(60) Provisional application No. 62/197,107, filed on Jul. 27, 2015.
(60) Provisional application No. 62/197,108, filed on Jul. 27, 2015.

(51) Int. Cl. H04R 23/00; H04R 3/00; H04R 17/02

(52) U.S. Cl. CPC H04R 23/008; H04R 17/02; H04R 3/005

(57) ABSTRACT

Laser microphone, laser-based microphone, and optical microphone utilizing mirrors having different properties. A laser microphone includes at least two mirrors: a front-side mirror, and a rear-side mirror. The reflectivity of the front-side mirror, is different from the reflectivity of the rear-side mirror; thereby increasing the efficiency or the accuracy of self-mixing of signals in the laser microphone. Additionally or alternatively, the front-side mirror has a first number of Distributed Bragg Reflector (DBR) layers; and the rear-side mirror has a second, different, number of DBR layers; thereby increasing the efficiency or the accuracy of self-mixing of signals in the laser microphone.

### CROSS-REFERENCE TO RELATED APPLICATIONS

This patent application claims priority and benefit from U.S. provisional patent application No. 62/197,023, filed on Jul. 26, 2015, which is hereby incorporated by reference in its entirety.

This patent application claims priority and benefit from U.S. provisional patent application No. 62/197,106, filed on Jul. 27, 2015, which is hereby incorporated by reference in its entirety.

This patent application claims priority and benefit from U.S. provisional patent application No. 62/197,107, filed on Jul. 27, 2015, which is hereby incorporated by reference in its entirety.

This patent application claims priority and benefit from U.S. provisional patent application No. 62/197,108, filed on Jul. 27, 2015, which is hereby incorporated by reference in its entirety.

### FIELD

The present invention is related to processing of signals.

### BACKGROUND

Audio and acoustic signals are captured and processed by millions of electronic devices. For example, many types of smartphones, tablets, laptop computers, and other electronic devices, may include an acoustic microphone able to capture audio. Such devices may allow the user, for example, to capture an audio/video clip, to record a voice message, to speak telephonically with another person, to participate in telephone conferences or audio/video conferences, to verbally provide speech commands to a computing device or electronic device, or the like.

### SUMMARY

The present invention may comprise, for example, systems, devices, and methods for enhancing and/or processing audio signals, acoustic signals and/or optical signals.

The present invention may comprise an optical microphone or laser microphone or laser-based microphone, which may comprise at least two minors: a front-side minor, and a rear-side minor. The reflectivity of the front-side minor, may be smaller than the reflectivity of the rear-side minor; thereby increasing the efficiency and/or accuracy of self-mixing of signals in the laser microphone. Additionally or alternatively, the front-side minor may have a first number of DBR layers (Distributed Bragg Reflector layers); and the rear-side minor may have a second, greater, number of DBR layers; thereby increasing the quality and/or magnitude and/or efficiency and/or accuracy and/or bandwidth of self-mixing of signals in the laser microphone.

The present invention may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

FIG. 2 is a schematic block-diagram illustration of another system, in accordance with some demonstrative embodiments of the present invention.

FIG. 3 which is a block-diagram illustration of a stand-alone laser microphone, in accordance with some demonstrative embodiments of the present invention.

FIG. 4 is a block-diagram illustration of a hybrid system, in accordance with some demonstrative embodiments of the present invention.

### DETAILED DESCRIPTION OF THE PRESENT INVENTION

The Applicants have realized that the efficiency and/or accuracy of a self-mixing chamber or a self-mix unit of a laser microphone or an optical microphone, may be increased or improved by providing particular types of minors within such laser microphone or optical microphone or optical speed sensor, or optical distance sensor, or optical vibration sensor.

In accordance with the present invention, for example, a laser microphone may comprise at least two minors: a front-side minor, and a rear-side minor. The reflectivity of the front-side minor, may be smaller (or in other embodiments, larger) than the reflectivity of the rear-side minor; thereby increasing the efficiency and/or accuracy of self-mixing of signals in the laser microphone. Additionally or alternatively, the front-side minor may have a first number of DBR layers (Distributed Bragg Reflector layers); and the rear-side minor may have a second, greater (or in other embodiments, smaller) number of DBR layers; thereby increasing the efficiency and/or accuracy of self-mixing of signals in the laser microphone.

The terms “reflectivity” or “reflection” or “reflectivity index” or “reflection index” or “reflection value” or “reflectivity value” or “reflective value” as used herein may comprise, for example, a light-reflection value or percentage-value, a light-reflection index, a Light Reflectance Value (LRV), or other value or index which measures the light that is reflected from a surface when illuminated by a light source. In some embodiments, “reflective value” may be expressed as a percentage value, from 0 percent to (and including) 100 percent; such that 100 percent indicates perfect and complete reflection of all the illuminated light, by a “perfect minor” that perfectly reflects all light (and all electromagnetic radiation) without absorbing any of it; and such that lower percentage values correspond to poorer or worse or reduced reflection or reflectivity of illuminated light. In accordance with the present invention, a particular percentage or value of reflectivity or reflection, may be achieved by utilizing particular shape(s) and/or curvature(s) and/or dielectric materials and/or optical coating material(s), and/or by setting or changing the number and/or the thickness of deposited optical coating layers, and/or by setting or changing the number and/or the thickness of deposited dielectric materials that are used for coating or constructing a reflective optics element.

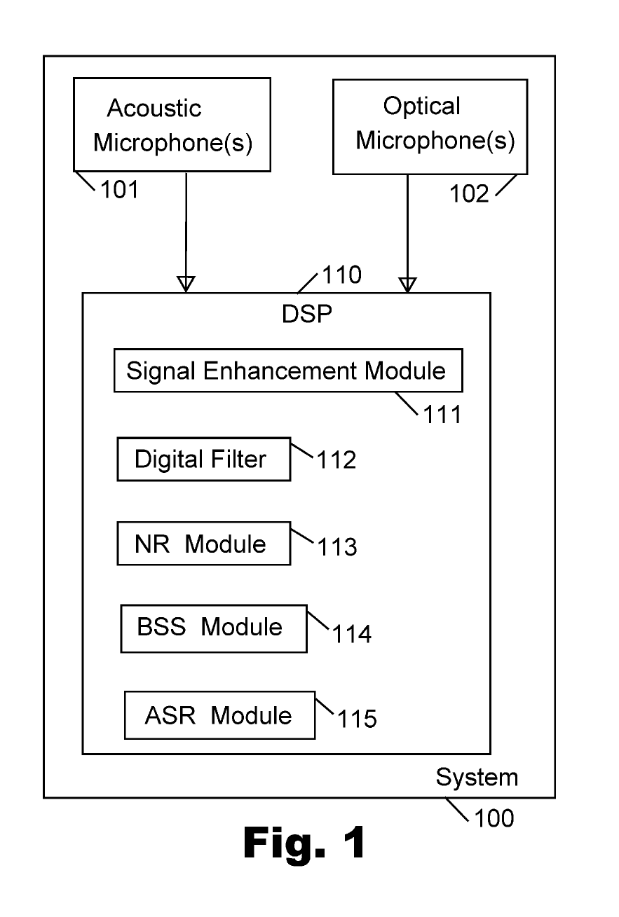

Reference is made to FIG. 1, which is a schematic block-diagram illustration of a system 100 in accordance with some demonstrative embodiments of the present invention. System 100 may be implemented as part of, for example: an electronic device, a smartphone, a tablet, a gaming device, a video-conferencing device, a telephone, a vehicular device, a vehicular system, a vehicular dashboard device, a navigation system, a mapping system, a gaming system, a portable device, a non-portable device, a computer, a laptop computer, a notebook computer, a tablet computer, a server computer, a handheld device, a wearable device, an Augmented Reality (AR) device or helmet or glasses or headset (e.g., similar to Google Glass), a Virtual Reality (VR) device or helmet or glasses or headset (e.g., similar to Oculus Rift), a smart-watch, a machine able to receive voice commands or speech-based commands, a speech-to-text converter, a Voice over Internet Protocol (VoIP) system or device, wireless communication devices or systems, wired communication devices or systems, image processing and/or video processing and/or audio processing workstations or servers or systems, electro-encephalogram (EEG) systems, medical devices or systems, medical diagnostic devices and/or systems, medical treatment devices and/or systems, and/or other suitable devices or systems. In some embodiments, system 100 may be implemented as a stand-alone unit or “chip” or module or device, able to capture audio and able to output enhanced audio, clean audio, noise-reduced audio, or otherwise improved or modified audio. System 100 may be implemented by utilizing one or more hardware components and/or software modules.

System 100 may comprise, for example: one or more acoustic microphone(s) 101; and one or more optical microphone(s) 102. Each one of the optical microphone(s) 102 may be or may comprise, for example, a laser-based microphone; which may include, for example, a laser-based transmitter (for example, to transmit a laser beam, e.g., towards a face or a mouth-area of a human speaker or human user, or towards other area-of-interest), an optical sensor to capture optical feedback returned from the area-of-interest; and an optical feedback processor to process the optical feedback and generate a signal (e.g., a stream of data; a data-stream; a data corresponding or imitating or emulating n audio signal or an acoustic signal) that corresponds to that optical feedback.

The acoustic microphone(s) 101 may acquire or sense or capture one or more acoustic signal(s); and the optical microphone(s) 102 may acquire or sense or capture one or more optical signal(s). The signals may be utilized by a digital signal processor (DSP) 110, or other controller or processor or circuit or Integrated Circuit (IC). For example, the DSP 110 may comprise, or may be implemented as, a signal enhancement module 111 able to enhance or improve the acoustic signal based on the receives signal; a digital filter 112 able to filter the acoustic signal based on the received signals; a Noise Reduction (NR) module 113 able to reduce noise from the acoustic signal based on the received signals; a Blind Source Separation (BSS) module 114 able to separate or differentiate among two or more sources of audio, based on the receives signals; a Speech Recognition (SR) or Automatic Speech Recognition (ASR) module 115 able to recognize spoken words based on the received signals; and/or other suitable modules or sub-modules.

In the discussion herein, the output generated by (or the signals captured by, or the signals processed by) an Acoustic microphone, may be denoted as “A” for Acoustic.

In the discussion herein, the output generated by (or the signals captured by, or the signals processed by) an Optical (or laser-based) microphone, may be denoted as “O” for Optical.

Although portions of the discussion herein may relate to, and although some of the drawings may depict, a single acoustic microphone, or two acoustic microphones, it is clarified that these are merely non-limiting examples of some implementations of the present invention. The present invention may be utilized with, or may comprise or may operate with, other number of acoustic microphones, or a batch or set or group of acoustic microphones, or a matrix or array of acoustic microphones, or the like.

Although portions of the discussion herein may relate to, and although some of the drawings may depict, a single optical (laser-based) microphone, or two optical (laser-based) microphones, it is clarified that these are merely non-limiting examples of some implementations of the present invention. The present invention may be utilized with, or may comprise or may operate with, other number of optical or laser-based microphones, or a batch or set or group of optical or laser-based microphones, or a matrix or array of optical or laser-based microphones, or the like.

Although portions of the discussion herein may relate, for demonstrative purposes, to two “sources” (e.g., two users, or two speakers, or a user and a noise, or a user and interference), the present invention may be used in conjunction with a system having a single source, or having two such sources, or having three or more such sources (e.g., one or more speakers, and/or one or more noise sources or interference sources).

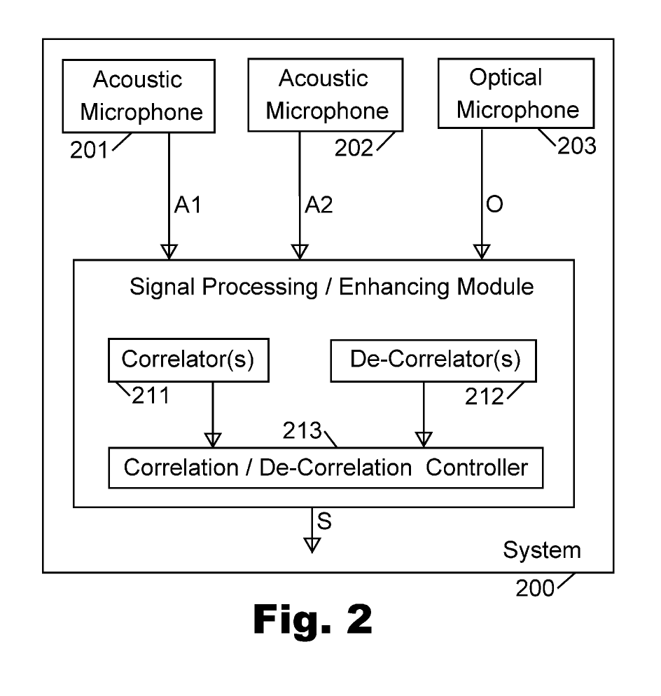

Reference is made to FIG. 2, which is a schematic block-diagram illustration of a system 200 in accordance with some demonstrative embodiments of the present invention. Optionally, system 200 may be a demonstrative implementation of system 100 of FIG. 1.

System 200 may comprise a plurality of acoustic microphones; for example, a first acoustic microphone 201 able to generate a first signal A1 corresponding to the audio captured by the first acoustic microphone 201; and a second acoustic microphone 202 able to generate a second signal A2 corresponding to the audio captured by the second acoustic microphone 202. System 200 may further comprise one or more optical microphones; for example, an optical microphone 203 aimed towards an area-of-interest, able to generate a signal O corresponding to the optical feedback captured by the optical microphone 203.

A signal processing/enhancing module 210 may receive as input: the first signal A1 of the first acoustic microphone 201, and the second signal A2 of the second acoustic microphone, and the signal O from the optical microphone. The signal processing/enhancing module 210 may comprise one or more correlator(s) 211, and/or one or more de-correlators 212; which may perform one or more, or a set or series or sequence of, correlation operations and/or de-correlation operations, on the received signals or on some of them or on combination(s) of them, as described herein, based on correlation/decorrelation logic implemented by a correlation/decorrelation controller 213; in order to achieve a particular goal, for example, to reduce noise(s) from acoustic signal(s), to improve or enhance or clean the acoustic signal(s), to distinguish or separate or differentiate among sources of acoustic signals or among speakers, to distinguish or separate or differentiate between a speaker (or multiple speakers) and noise or background noise or ambient noise, to operate as digital filter on one or more of the received signals, and/or to perform other suitable operations. The signal processing/enhancing module 210 may output an enhanced reduced-noise signal S, which may be utilized for such purposes and/or for other purposes, by other units or modules or components of system 200, or by units or components or modules which may be external to (and/or remote from) system 200.

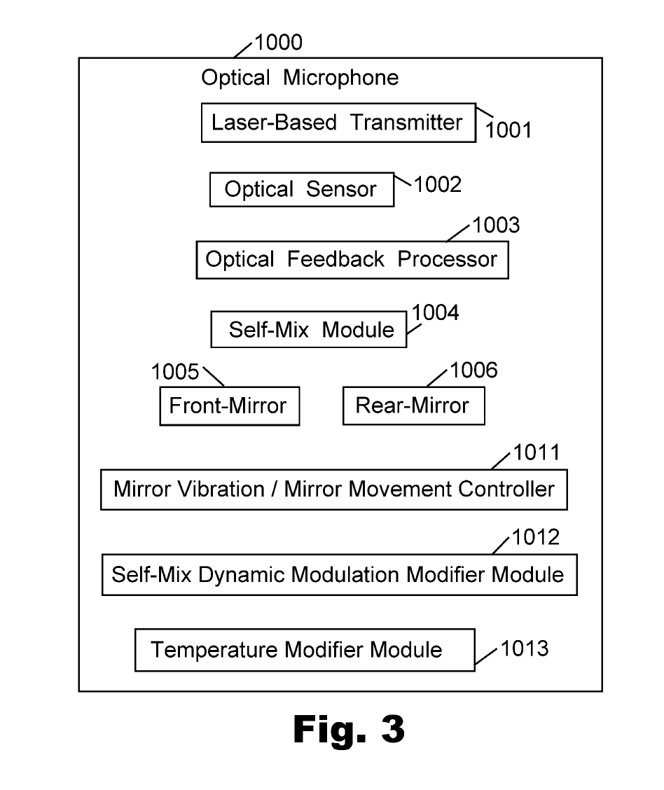

Reference is made to FIG. 3, which is a schematic block-diagram illustration of an optical microphone 1000 (or laser-based microphone, or laser microphone, or optical speed sensor, or optical distance sensor, or optical vibration sensor), in accordance with some demonstrative embodiments of the present invention. Optical microphone 1000 may comprise, for example, a laser-based transmitter 1001 able to generate and/or transmit a laser beam towards an area-of-interest; an optical sensor 1002 able to capture optical feedback received or reflected from that area-of-interest or from the laser; and an optical feedback processor 1003 able to process the captured optical feedback, taking into account also information about the transmitted laser beam(s) and their timing.

In some embodiments, the optical microphone 1001 and/or its components may be implemented as (or may comprise) a Self-Mix module 1004; for example, utilizing a self-mixing interferometry measurement technique (or feedback interferometry, or induced-modulation interferometry, or backscatter modulation interferometry, or Doppler interferometry), in which a laser beam is reflected from an object, back into the laser. The reflected light interferes with the light generated inside the laser, and this causes changes in the optical and/or electrical properties of the laser. Information about the target object and the laser itself may be obtained by analyzing these changes in behavior or properties.

For example, the self-mix module 1004 may comprise a front-minor 1005 (or front-side minor) and a rear-minor 1006 (or rear-side mirror). For example, the front-minor 1005 may be located closer to the target or the area-of-interest, relative to the rear-minor 1006.

In accordance with some embodiments of the present invention, the self-mix sensitivity or efficiency or accuracy may be increased, by decreasing or reducing the reflectivity of the front-mirror 1005 of the laser, such that the front-minor 1005 reflectivity may be smaller than the rear-mirror 10006 reflectivity. In accordance with some other embodiments of the present invention, the self-mix sensitivity or efficiency or accuracy may be increased, by increasing the reflectivity of the front-minor 1005 of the laser, such that the front-minor 1005 reflectivity may be greater than the rear-minor 10006 reflectivity

In a demonstrative implementation, for example, the reflectivity of the rear-minor 1006 may be 99.9 percent, or may be approximately 99.9 percent. Additionally, the reflectivity of the front-minor 1005, may be: smaller than 99.9 percent, or smaller than 99.8 percent, or smaller than 99.7 percent, or smaller than 99.6 percent, or smaller than 99.5 percent, or smaller than 99.4 percent, or smaller than 99.3 percent, or smaller than 99.2 percent, or smaller than 99.1 percent, or smaller than 99.0 percent; or may be 99.8 percent, or 99.7 percent, or 99.6 percent, or 99.5 percent, or 99.4 percent, or 99.3 percent, or 99.2 percent, or 99.1 percent, or 99.0 percent; or may be 98 percent, or 97 percent, or 95 percent, or 90 percent, or 85 percent, or 80 percent, or 75 percent, or 70 percent, or 65 percent, or 60 percent, or 55 percent, or 50 percent, or 45 percent, or 40 percent, or 35 percent; or 32 percent, or 31 percent, or 30 percent, or 29 percent, or 25 percent; or may be, for example, smaller than 98 percent, or smaller than 97 percent, or smaller than 95 percent, or smaller than 90 percent, or smaller than 85 percent, or smaller than 80 percent, or smaller than 75 percent, or smaller than 70 percent, or smaller than 65 percent, or smaller than 60 percent, or smaller than 55 percent, or smaller than 50 percent, or smaller than 45 percent, or smaller than 40 percent, or smaller than 35 percent; or smaller than 32 percent, or smaller than 31 percent, or smaller than 30 percent, or smaller than 29 percent, or smaller than 25 percent.

In another demonstrative implementation, the reflectivity of the front-minor 1005 may be at least K percent smaller relative to the reflectivity of the rear-mirror 1006; where K may be, for example, 0.01 or 0.02 or 0.05 or 0.08 or 0.1 or 0.2 or 0.5 or 0.75or 1 or 2 or 3 or 4 or 5, or 10, or 15, or 20, or 25, or 33, or 50, or may have other suitable value.

In another demonstrative implementation, for example, the reflectivity of the front-minor 1005 may be 99.9 percent, or may be approximately 99.9 percent. Additionally, the reflectivity of the rear-minor 1006, may be: smaller than 99.9 percent, or smaller than 99.8 percent, or smaller than 99.7 percent, or smaller than 99.6 percent, or smaller than 99.5 percent, or smaller than 99.4 percent, or smaller than 99.3 percent, or smaller than 99.2 percent, or smaller than 99.1 percent, or smaller than 99.0 percent; or may be 99.8 percent, or 99.7 percent, or 99.6 percent, or 99.5 percent, or 99.4 percent, or 99.3 percent, or 99.2 percent, or 99.1 percent, or 99.0 percent; or may be 98 percent, or 97 percent, or 95 percent, or 90 percent, or 85 percent, or 80 percent, or 75 percent, or 70 percent, or 65 percent, or 60 percent, or 55 percent, or 50 percent, or 45 percent, or 40 percent, or 35 percent; or 32 percent, or 31 percent, or 30 percent, or 29 percent, or 25 percent; or may be, for example, smaller than 98 percent, or smaller than 97 percent, or smaller than 95 percent, or smaller than 90 percent, or smaller than 85 percent, or smaller than 80 percent, or smaller than 75 percent, or smaller than 70 percent, or smaller than 65 percent, or smaller than 60 percent, or smaller than 55 percent, or smaller than 50 percent, or smaller than 45 percent, or smaller than 40 percent, or smaller than 35 percent; or smaller than 32 percent, or smaller than 31 percent, or smaller than 30 percent, or smaller than 29 percent, or smaller than 25 percent.

In another demonstrative implementation, the reflectivity of the rear-minor 1006 may be at least K percent smaller relative to the reflectivity of the front-minor 1005; where K may be, for example, 0.01 or 0.02 or 0.05 or 0.08 or 0.1 or 0.2 or 0.5 or 0.75 or 1 or 2 or 3 or 4 or 5, or 10, or 15, or 20, or 25, or 33, or 50, or may have other suitable value.

In another demonstrative implementation, the laser transmitter 1001 may be implemented by using a Vertical-Cavity Surface-Emitting Laser (VCSEL), for example, producing laser beam emission perpendicularly from its top surface or other suitable semiconductor laser diode.

In some embodiments, for example, the front-minor 1005 may have a smaller number (“DBRfront”) of DBR layers (Distributed Bragg Reflector layers), relative to the number of DBR layers of the rear-minor 1005 (“DBRrear”); such that DBRfront is smaller (e.g., smaller by K percent, or by N layers wherein N is a positive integer) than DBRrear; thereby enabling reduced or lower reflectivity of the front-minor 1005, compared to (or relative to) the reflectivity of the rear-minor 1006.

In some other embodiments, for example, the front-minor 1005 may have a greater number (“DBRfront”) of DBR layers (Distributed Bragg Reflector layers), relative to the number of DBR layers of the rear-minor 1005 (“DBRrear”); such that DBRfront is greater (e.g., greater by K percent, or by N layers) than DBRrear; thereby enabling reduced or lower reflectivity of the front-mirror 1005, compared to (or relative to) the reflectivity of the rear-minor 1006.

In some implementations, this unique structure of the two minors may be counter-intuitive and non-obvious, since, for example, the intentional reduction of the reflectivity of the front-minor 1005 (or, of the rear-mirror 1006, in other embodiments), may be in contrast to the approach of conventional laser systems, which attempt to improve the strength and/or the quality of the outputted laser beam and that may utilize perfect minors or near-perfect mirrors. However, Applicants have realized that the counter-intuitive approach of the present invention, which may reduce the strength and/or the quality of the outputted laser beam, may actually improve and/or enhance the performance and/or the accuracy of the Self-Mix module of the laser microphone or optical microphone; for example, since the present invention causes less inter-chamber reflections of beam(s) between the front-minor 1005 and the rear-minor 1006 (or vice versa).

Accordingly, some embodiments of the present invention may transmit a laser beam that may be less effective or less efficient as a transmitted laser, or may be “inferior” to standard laser beams with respect to threshold current and/or power efficiency; but at the same time may be more effective or more efficient for the particular purpose of performing self-mix interferometry measurement, and may thus produce a higher or cleaner or improved or more-efficient Self-Mix signal or measurement.

The terms “laser” or “laser transmitter” as used herein may comprise or may be, for example, a stand-alone laser transmitter, a laser transmitter unit, a laser generator, a component able to generate and/or transmit a laser beam or a laser ray, a laser drive, a laser driver, a laser transmitter associated with a modulator, a combination of laser transmitter with modulator, a combination of laser driver or laser drive with modulator, or other suitable component able to generate and/or transmit a laser beam.

The term “acoustic microphone” as used herein, may comprise one or more acoustic microphone(s) and/or acoustic sensor(s); or a matrix or array or set or group or batch or arrangement of multiple such acoustic microphones and/or acoustic sensors; or one or more sensors or devices or units or transducers or converters (e.g., an acoustic-to-electric transducer or converter) able to convert sound into an electrical signal; a microphone or transducer that utilizes electromagnetic induction (e.g., a dynamic microphone) and/or capacitance change (e.g., a condenser microphone) and/or piezoelectricity (e.g., a piezoelectric microphones) in order to produce an electrical signal from air pressure variations; a microphone that may optionally be connected to, or may be associated with or may comprise also, a pre-amplifier or an amplifier; a carbon microphone; a carbon button microphone; a button microphone; a ribbon microphone; an electret condenser microphone; a capacitor microphone; a magneto-dynamic microphone; a dynamic microphone; an electrostatic microphone; a Radio Frequency (RF) condenser microphone; a crystal microphone; a piezo microphone or piezoelectric microphone; and/or other suitable types of audio microphones, acoustic microphones and/or sound-capturing microphones.

The term “laser microphone” as used herein, may comprise, for example: one or more laser microphone(s) or sensor(s); one or more laser-based microphone(s) or sensor(s); one or more optical microphone(s) or sensor(s); one or more microphone(s) or sensor(s) that utilize coherent electromagnetic waves; one or more optical sensor(s) or laser-based sensor(s) that utilize vibrometry, or that comprise or utilize a vibrometer; one or more optical sensor(s) and/or laser-based sensor(s) that comprise a self-mix module, or that utilize self-mixing interferometry measurement technique (or feedback interferometry, or induced-modulation interferometry, or backscatter modulation interferometry), in which a laser beam is reflected from an object, back into the laser, and the reflected light interferes with the light generated inside the laser, and this causes changes in the optical and/or electrical properties of the laser, and information about the target object and the laser itself may be obtained by analyzing these changes.

The terms “vibrating” or “vibrations” or “vibrate” or similar terms, as used herein, refer and include also any other suitable type of motion, and may not necessarily require vibration or resonance per se; and may include, for example, any suitable type of motion, movement, shifting, drifting, slanting, horizontal movement, vertical movement, diagonal movement, one-dimensional movement, two-dimensional movement, three-dimensional movement, or the like.

In some embodiments of the present invention, which may optionally utilize a laser microphone, only “safe” laser beams or sources may be used; for example, laser beam(s) or source(s) that are known to be non-damaging to human body and/or to human eyes, or laser beam(s) or source(s) that are known to be non-damaging even if accidently hitting human eyes for a short period of time. Some embodiments may utilize, for example, Eye-Safe laser, infra-red laser, infra-red optical signal(s), low-strength laser, and/or other suitable type(s) of optical signals, optical beam(s), laser beam(s), infra-red beam(s), or the like. It would be appreciated by persons of ordinary skill in the art, that one or more suitable types of laser beam(s) or laser source(s) may be selected and utilized, in order to safely and efficiently implement the system and method of the present invention. In some embodiments, optionally, a human speaker or a human user may be requested to wear sunglasses or protective eye-gear or protective goggles, in order to provide additional safety to the eyes of the human user which may occasionally be “hit” by such generally-safe laser beam, as an additional precaution.

In some embodiments which may utilize a laser microphone or optical microphone, such optical microphone (or optical sensor) and/or its components may be implemented as (or may comprise) a Self-Mix module; for example, utilizing a self-mixing interferometry measurement technique (or feedback interferometry, or induced-modulation interferometry, or backscatter modulation interferometry), in which a laser beam is reflected from an object, back into the laser. The reflected light interferes with the light generated inside the laser, and this causes changes in the optical and/or electrical properties of the laser. Information about the target object and the laser itself may be obtained by analyzing these changes. In some embodiments, the optical microphone or laser microphone operates to remotely detect or measure or estimate vibrations of the skin (or the surface) of a face-point or a face-region or a face-area of the human speaker (e.g., mouth, mouth-area, lips, lips-area, cheek, nose, chin, neck, throat, ear); and/or to remotely detect or measure or estimate the direct changes in skin vibrations; rather than trying to measure indirectly an effect of spoken speech on a vapor that is exhaled by the mouth of the speaker, and rather than trying to measure indirectly an effect of spoken speech on the humidity or relative humidity or gas components or liquid components that may be produced by the mouth due to spoken speech.

The present invention may be utilized in, or with, or in conjunction with, a variety of devices or systems that may benefit from noise reduction and/or speech enhancement; for example, a smartphone, a cellular phone, a cordless phone, a video conference system or device, a tele-conference system or device, an audio/video camera, a web-camera or web-cam, a landline telephony system, a cellular telephone system, a voice-messaging system, a Voice-over-IP system or network or device, a vehicle, a vehicular dashboard, a vehicular audio system or microphone, a navigation device or system, a vehicular navigation device or system, a mapping or route-guidance device or system, a vehicular route-guidance or device or system, a dictation system or device, Speech Recognition (SR) device or module or system, Automatic Speech Recognition (ASR) module or device or system, a speech-to-text converter or conversion system or device, a laptop computer, a desktop computer, a notebook computer, a tablet, a phone-tablet or “phablet” device, a gaming device, a gaming console, a wearable device, a smart-watch, a Virtual Reality (VR) device or helmet or glasses or headgear, an Augmented Reality (AR) device or helmet or glasses or headgear, an Internet of Things (IoT) device or appliance, an Internet-connected device or appliance, a wireless-connected device or appliance, a device or system or module that utilizes speech-based commands or audio commands, a device or system that captures and/or records and/or processes and/or analyzes audio signals and/or speech and/or acoustic signals, and/or other suitable systems and devices.

Some embodiments of the present invention may provide or may comprise a laser-based device or apparatus or system, a laser-based microphone or sensor, a laser microphone or sensor, an optical microphone or sensor, a hybrid acoustic-optical sensor or microphone, a combined acoustic-optical sensor or microphone, and/or a system that comprises or utilizes one or more of the above.

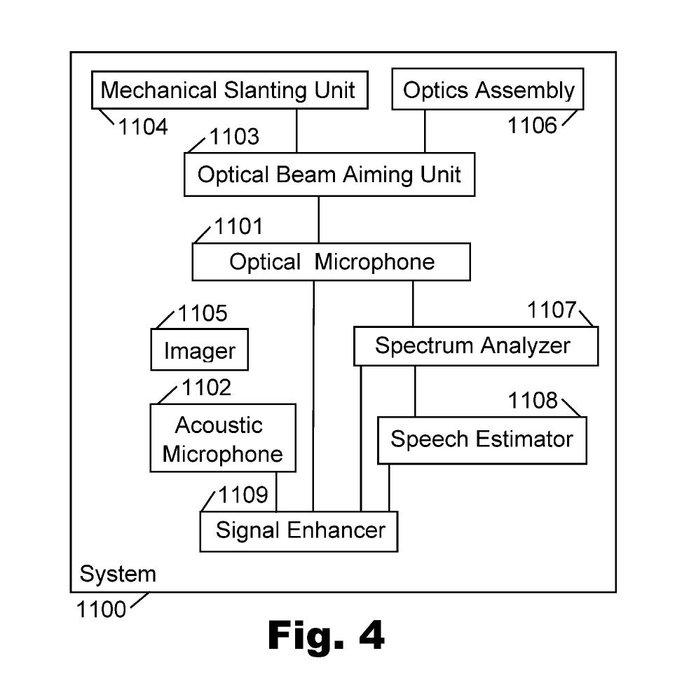

Reference is made to FIG. 4, which is a schematic block-diagram illustration of a system 1100, in accordance with some demonstrative embodiments of the present invention.

System 1100 may comprise, for example, an optical microphone 1101 able to transmit an optical beam (e.g., a laser beam) towards a target (e.g., a face of a human speaker), and able to capture and analyze the optical feedback that is reflected from the target, particularly from vibrating regions or vibrating face-regions or face-portions of the human speaker. The optical microphone 1101 may be or may comprise or may utilize a Self-Mix (SM) chamber or unit, an interferometry chamber or unit, an interferometer, a vibrometer, a targeted vibrometer, or other suitable component, able to analyze the spectrum of the received optical signal with reference to the transmitted optical beam, and able to remotely estimate the audio or speech or utterances generated by the target (e.g., the human speaker).

Optionally, system 1100 may comprise an acoustic microphone 1102 or an audio microphone, which may capture audio. Optionally, the analysis results of the optical feedback may be utilized in order to improve or enhance or filter the captured audio signal; and/or to reduce or cancel noise(s) from the captured audio signal. Optionally, system 1100 may be implemented as a hybrid acoustic-and-optical sensor, or as a hybrid acoustic-and-optical sensor. In other embodiments, system 1100 need not necessarily comprise an acoustic microphone. In yet other embodiments, system 1100 may comprise optical microphone 1102 and may not comprise any acoustic microphones, but may operate in conjunction with an external or a remote acoustic microphone.

System 1100 may further comprise an optical beam aiming unit 1103 (or tilting unit, or slanting unit, or positioning unit, or targeting unit, or directing unit), for example, implemented as a laser beam directing unit or aiming unit or other unit or module able to direct a transmitted optical beam (e.g., a transmitted laser beam) towards the target, and/or able to fine-tune or modify the direction of such optical beam or laser beam. The directing or alignment of the optical beam or laser beam, towards the target, may be performed or achieved by using one or more suitable mechanisms.

In a first example, the optical microphone 1101 may be fixedly mounted or attached or located at a first location or point (e.g., on a vehicular dashboard; on a frame of a screen of a laptop computer), and may generally point or be directed towards an estimated location or a general location of a human speaker that typically utilizes such device (e.g., aiming or targeting an estimated general location of a head of a driver in a vehicle; or aiming or targeting an estimated general location of a head of a laptop computer user); based on a fixed or pre-mounted angular slanting or positioning (e.g., performed by a maker of the vehicular dashboard or vehicle, or by the maker of the laptop computer).

In a second example, the optical microphone may be mounted on a wall of a lecture hall; and may be fixedly pointing or aiming its laser beam or its optical beam towards a general location of a stage or a podium in that lecture hall, in order to target a human speaker who is a lecturer.

In a third example, a motor or engine or robotic arm or other mechanical slanting unit 1104 may be used, in order to align or slant or tilt the direction of the optical beam or laser beam of the optical microphone, towards an actual or an estimated location of a human speaker; optionally via a control interface that allows an administrator to command the movement or the slanting of the optical microphone towards a desired target (e.g., similar to the manner in which an optical camera or an imager or a video-recording device may be moved or tilted via a control interface, a pan-tilt-zoom (PTZ) interface, a robotic arm, or the like).

In a fourth example, an imager 1105 or camera may be used in order to capture images or video of the surrounding of the optical microphone; and a face-recognition module or image-recognition module or a face-identifying module or other Computer Vision algorithm or module may be used in order to analyze the captured images or video and to determine the location of a human speaker (or a particular, desired, human speaker), and to cause the slanting or aiming or targeting or re-aligning of the optical beam to aim towards the identified human speaker. In a fifth example, a human speaker may be requested to wear or to carry a particular tag or token or article or object, having a pre-defined shape or color or pattern which is not typically found at random (e.g., tag or a button showing a green triangle within a yellow square); and an imager or camera may scan an area or a surrounding of system 1100, may analyze the images or video to detect or to find the pre-defined tag, and may aim the optical microphone towards the tag, or towards a pre-defined or estimated offset distance from that tag (e.g., a predefined K degrees of slanting upwardly or vertically relative to the detected tag, if the human speaker is instructed to carry the tag or to wear the tag on his jacket pocket).

In a sixth example, an optics assembly 1106 or optics arrangement (e.g., one or more minors, flat minors, concave minors, convex minors, lenses, prisms, beam-splitters, focusing elements, diffracting elements, diffractive elements, condensing elements, and/or other optics elements or optical elements) may be utilized in order to direct or aim the optical beam or laser beam towards a known or estimated or general location of a target or a speaker or a human face. The optics assembly may be fixedly mounted in advance (e.g., within a vehicle, in order to aim or target a vehicular optical sensor towards a general-location of a driver face), or may be dynamically adjusted or moved or tilted or slanted based on real-time information regarding the actual or estimated location of the speaker or his head (e.g., determined by using an imager, or determined by finding a Signal to Noise Ratio (SNR) value that is greater than a threshold value).

In a seventh example, the optical microphone may move or may “scan” a target area (e.g., by being moved or slanted via the mechanical slanting unit 1104); and may remain at, or may go-back to, a particular direction in which the Signal to Noise Ratio (SNR) value was the maximal, or optimal, or greater than a threshold value.

In an eighth example, particularly if the human speaker is moving on a stage or moving in a room, or moves his face to different directions, the human speaker may be requested or required to stand at a particular spot or location in order to enable the system to efficiently work (e.g., similarly to the manner in which a singer or a performer is required to stand in proximity to a wired acoustic microphone which is mounted on a microphone stand); and/or the human speaker may be requested or required to look to a particular direction or to move his face to a particular direction (e.g., to look directly towards the optical microphone) in order for the system to efficiently operate (e.g., similar to the manner in which a singer or a performer may be requested to look at a camera or a video-recorder, or to put his mouth in close proximity to an acoustic microphone that he holds).

Other suitable mechanisms may be used to achieve or to fine-tune aiming, targeting and/or aligning of the optical beam with the desired target.

It is clarified that the optical microphone and/or the system of the present invention, need not be continuously aligned with the target or the human speaker, and need not necessarily “hit” the speaker continuously with laser beam or optical beam. Rather, in some embodiments, the present invention may operate only during time-periods in which the optical beam or laser beam actually “hits” the face of the speaker, or actually causes reflection of optical feedback from vibrating face-regions of the human speaker. In some embodiments, the system may operate or may efficiently operate at least during time period(s) in which the laser beam(s) or the optical signal(s) actually hit (or reach, or touch) the face or the mouth or the mouth-region of a speaker; and not in other time-periods or time-slots. In some embodiments, the system and/or method need not necessarily provide continuous speech enhancement or continuous noise reduction or continuous speech detection; but rather, in some embodiments the speech enhancement and/or noise reduction and/or speech detection may be achieved in those specific time-periods in which the laser beam(s) actually hit the face of the speaker and cause a reflection of optical feedback from vibrating surfaces or face-regions. In some embodiments, the system may operate only during such time periods (e.g., only a few minutes out of an hour; or only a few seconds out of a minute) in which such actual “hit” of the laser beam with the face-region is achieved. In other embodiments, continuous or substantially-continuous noise reduction and/or speech enhancement may be achieved; for example, in a vehicular system in which the laser beam is directed towards the location of the head or the face of the driver.

In accordance with the present invention, the optical microphone 1101 may comprise a self-mix chamber or unit or self-mix interferometer or a targeted vibrometer, and may utilize reflected optical feedback (e.g., reflected feedback of a transmitted laser beam) in order to remotely measure or estimate vibrations of the facial skin or facial-regions head-regions of a human speaker, utilizing a spectrum analyzer 1107 in order to analyze the optical feedback with reference to the transmitted optical feedback, and utilizing a speech estimator unit 1108 to estimate or extract a signal that corresponds to speech or audio that is generated or uttered by that human speaker.

Optionally, system 1100 may comprise a signal enhancer 1109, which may enhance, filter, improve and/or clean the acoustic signal that is captured by acoustic microphone 1102, based on output generated by the optical microphone 1101. For example, system 1100 may dynamically generate and may dynamically apply, to the acoustic signal captured by the acoustic microphone 1102, a digital filter which may be dynamically constructed by taking into account the output of the optical microphone 1101, and/or by taking into account an analysis of the optical feedback or optical signal(s) that are reflected back from the face of the human speaker.

System 1100 may further comprise any, or some, or all, of the components and/or systems that are depicted in any of FIGS. 1-3, and/or that are discussed with reference to FIGS. 1-3 and/or above and/or herein.

The present invention may be utilized in conjunction with one or more types of acoustic samples or data samples, or a voice sample or voice print, which may not necessarily be merely an acoustic recording or raw acoustic sounds, and/or which may not necessarily be a cleaned or digitally-cleaned or filtered or digitally-filtered acoustic recording or acoustic data. For example, the present invention may utilize, or may operate in conjunction with, in addition to or instead of the other samples or data as described above, one or more of the following: (a) the speech signal, or estimated or detected speech signal, as determined by the optical microphone 1101 based on an analysis of the self-mixed optical signals; (b) an acoustic sample as captured by the acoustic microphone 1102, by itself and/or in combination with the speech signal estimated by the optical microphone 1101; (c) an acoustic sample as captured by the acoustic microphone 1102 and as cleaned or digitally-cleaned or filtered or digitally-filtered or otherwise digitally-adjusted or digitally-modified based on the speech signal estimated by the optical microphone 1101; (d) a voice print or speech sample which is acquired and/or produced by utilizing one or more biometric algorithms or sub-modules, such as a Neural Network module or a Hidden Markov Model (HMM) unit, which may utilize both the acoustic signal and the optical signal (e.g., the self-mixed signals of the optical microphone 1101) in order to extract more data and/or more user-specific characteristics from utterances of the human speaker.

Some embodiments of the present invention may comprise an optical microphone or laser microphone or a laser-based microphone, or optical sensor or laser sensor or laser-based sensor, which utilizes multiple lasers or multiple laser beams or multiple laser transmitters, in conjunction with a single laser drive component and/or a single laser receiver component, thereby increasing or improving the efficiency of self-mix techniques or module or chamber (or self-mix interferometry techniques or module or chamber) utilized by such optical or laser-based microphone or sensor.

In some embodiments of the present invention, which may optionally utilize a laser microphone or optical microphone, the laser beam or optical beam may be directed to an estimated general-location of the speaker; or to a pre-defined target area or target region in which a speaker may be located, or in which a speaker is estimated to be located. For example, the laser source may be placed inside a vehicle, and may be targeting the general location at which a head of the driver is typically located. In other embodiments, a system may optionally comprise one or more modules that may, for example, locate or find or detect or track, a face or a mouth or a head of a person (or of a speaker), for example, based on image recognition, based on video analysis or image analysis, based on a pre-defined item or object (e.g., the speaker may wear a particular item, such as a hat or a collar having a particular shape and/or color and/or characteristics), or the like. In some embodiments, the laser source(s) may be static or fixed, and may fixedly point towards a general-location or towards an estimated-location of a speaker. In other embodiments, the laser source(s) may be non-fixed, or may be able to automatically move and/or change their orientation, for example, to track or to aim towards a general-location or an estimated-location or a precise-location of a speaker. In some embodiments, multiple laser source(s) may be used in parallel, and they may be fixed and/or moving.

In some demonstrative embodiments of the present invention, which may optionally utilize a laser microphone or optical microphone, the system and method may efficiently operate at least during time period(s) in which the laser beam(s) or the optical signal(s) actually hit (or reach, or touch) the face or the mouth or the mouth-region of a speaker. In some embodiments, the system and/or method need not necessarily provide continuous speech enhancement or continuous noise reduction; but rather, in some embodiments the speech enhancement and/or noise reduction may be achieved in those time-periods in which the laser beam(s) actually hit the face of the speaker. In other embodiments, continuous or substantially-continuous noise reduction and/or speech enhancement may be achieved; for example, in a vehicular system in which the laser beam is directed towards the location of the head or the face of the driver.

The system(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules. The system(s) of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

Some embodiments of the present invention may comprise, or may utilize, or may be utilized in conjunction with, one or more elements, units, devices, systems and/or methods that are described in U.S. Pat. No. 7,775,113, titled “Sound sources separation and monitoring using directional coherent electromagnetic waves”, which is hereby incorporated by reference in its entirety.

Some embodiments of the present invention may comprise, or may utilize, or may be utilized in conjunction with, one or more elements, units, devices, systems and/or methods that are described in U.S. Pat. No. 8,286,493, titled “Sound sources separation and monitoring using directional coherent electromagnetic waves”, which is hereby incorporated by reference in its entirety.

Some embodiments of the present invention may comprise, or may utilize, or may be utilized in conjunction with, one or more elements, units, devices, systems and/or methods that are described in U.S. Pat. No. 8,949,118, titled “System and method for robust estimation and tracking the fundamental frequency of pseudo periodic signals in the presence of noise”, which is hereby incorporated by reference in its entirety.

Some embodiments of the present invention may comprise, or may utilize, or may be utilized in conjunction with, one or more elements, units, devices, systems and/or methods that are described in U.S. Pat. No. 9,344,811, titled “System and method for detection of speech related acoustic signals by using a laser microphone”, which is hereby incorporated by reference in its entirety.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

In some embodiments of the present invention, a system includes a laser microphone comprising: (a) a laser transmitter to transmit an outgoing laser beam towards a human speaker; (b) a self-mix interferometry unit to receive an optical feedback signal reflected from the face of the human speaker, and to generate an optical self-mix signal by self-mixing interferometry of the laser power and the received optical feedback signal; wherein the laser microphone comprises at least a front-side minor and a rear-side minor, wherein the front-side minor of the laser microphone has a first reflectivity, wherein the rear-side minor of the laser microphone has a second, different, reflectivity.

In some embodiments, one of said rear-side minor and said front-side minor of the laser microphone has reflectivity of 99.9 percent; wherein the other one of said rear-side minor and said front-side minor of the laser microphone has reflectivity of not more than 99.8 percent.

In some embodiments, one of said rear-side minor and said front-side minor of the laser microphone has reflectivity of 99.9 percent; wherein the front-side minor of the laser microphone has reflectivity of not more than 99.7 percent.

In some embodiments, one of said rear-side minor and said front-side minor of the laser microphone has reflectivity of 99.9 percent; wherein the other one of said rear-side minor and said front-side minor of the laser microphone has reflectivity of not more than 99.5 percent.

In some embodiments, one of said rear-side minor and said front-side minor of the laser microphone has reflectivity of 99.8 percent; wherein the other one of said rear-side minor and said front-side minor of the laser microphone has reflectivity of not more than 99.7 percent.

In some embodiments, one of said rear-side minor and said front-side minor of the laser microphone has reflectivity of 99.0 percent; wherein the other one of said rear-side minor and said front-side minor of the laser microphone has reflectivity of not more than 98.0 percent.

In some embodiments, reflectivity of the front-side minor is at least 0.1 percent smaller than reflectivity of the rear-side minor. In some embodiments, reflectivity of the front-side minor is at least 0.25 percent smaller than reflectivity of the rear-side minor. In some embodiments, reflectivity of the front-side minor is at least 0.50 percent smaller than reflectivity of the rear-side minor. In some embodiments, reflectivity of the front-side minor is at least 1.0 percent smaller than reflectivity of the rear-side minor. In some embodiments, reflectivity of the front-side minor is at least 2.0 percent smaller than reflectivity of the rear-side minor. In some embodiments, reflectivity of the front-side minor is at least 5.0 percent smaller than reflectivity of the rear-side minor. In some embodiments, reflectivity of the front-side minor is at least 10.0 percent smaller than reflectivity of the rear-side minor.

In some embodiments, reflectivity of the front-side minor is at least 0.25 percent greater than reflectivity of the rear-side minor. In some embodiments, reflectivity of the front-side minor is at least 0.50 percent greater than reflectivity of the rear-side minor. In some embodiments, reflectivity of the front-side minor is at least 1.0 percent greater than reflectivity of the rear-side minor. In some embodiments, reflectivity of the front-side minor is at least 2.0 percent greater than reflectivity of the rear-side minor. In some embodiments, reflectivity of the front-side minor is at least 5.0 percent greater than reflectivity of the rear-side mirror. In some embodiments, reflectivity of the front-side minor is at least 10.0 percent greater than reflectivity of the rear-side minor.

In some embodiments, one of said rear-side minor and said front-side minor of the laser microphone has a first reflectivity in a range of 28 to 33 percent; wherein the other one of said rear-side minor and said front-side minor of the laser microphone has a second, different, reflectivity that is at least 1 percent smaller than said first reflectivity.

In some embodiments, one of said rear-side minor and said front-side minor of the laser microphone has reflectivity in a range of 25 to 35 percent; wherein the other one of said rear-side minor and said front-side minor of the laser microphone has a second, different, reflectivity that is at least 1 percent smaller than said first reflectivity.

In some embodiments, the front-side minor of the laser microphone has a first number of Distributed Bragg Reflector (DBR) layers; wherein the rear-side minor of the laser microphone has a second, greater, number of Distributed Bragg Reflector (DBR) layers.

In some embodiments, the front-side minor of the laser microphone has a first number of Distributed Bragg Reflector (DBR) layers; wherein the rear-side minor of the laser microphone has a second number of Distributed Bragg Reflector (DBR) layers which is greater than the first number of DBR layers by at least 1 percent.

In some embodiments, the front-side minor of the laser microphone has a first number of Distributed Bragg Reflector (DBR) layers; wherein the rear-side minor of the laser microphone has a second number of Distributed Bragg Reflector (DBR) layers which is greater than the first number of DBR layers by at least 2 percent.

In some embodiments, the front-side minor of the laser microphone has a first number of Distributed Bragg Reflector (DBR) layers; wherein the rear-side minor of the laser microphone has a second number of Distributed Bragg Reflector (DBR) layers which is greater than the first number of DBR layers by at least 5 percent.

In some embodiments, the front-side minor of the laser microphone has a first number of Distributed Bragg Reflector (DBR) layers; wherein the rear-side minor of the laser microphone has a second number of Distributed Bragg Reflector (DBR) layers which is smaller than the first number of DBR layers by at least 1 percent.

In some embodiments, the front-side mirror of the laser microphone has a first number of Distributed Bragg Reflector (DBR) layers; wherein the rear-side minor of the laser microphone has a second number of Distributed Bragg Reflector (DBR) layers which is smaller than the first number of DBR layers by at least 2 percent.

In some embodiments, the front-side mirror of the laser microphone has a first number of Distributed Bragg Reflector (DBR) layers; wherein the rear-side minor of the laser microphone has a second number of Distributed Bragg Reflector (DBR) layers which is smaller than the first number of DBR layers by at least 5 percent.

In some embodiments, a difference between (i) the reflectivity of the front-side minor and (ii) the reflectivity of the rear-side minor, increases at least one of: efficiency, usefulness, magnitude, bandwidth, signal-to-noise ratio, of said self-mixing interferometry performed by said self-mix interferometry unit.

In some embodiments, a difference between (i) the first reflective value of the front-side minor and (ii) the second reflective value of the rear-side minor, reduced a strength of said outgoing laser beam and also increases at least one of: efficiency, usefulness, magnitude, bandwidth, signal-to-noise ratio, of said self-mixing interferometry performed by said self-mix interferometry unit.

In some embodiments, the system further comprises at least one acoustic microphone; wherein the system is a hybrid acoustic-and-optical sensor.

In some embodiments, the system further comprises at least one acoustic microphone; wherein the system is a hybrid acoustic-and-optical sensor which is comprised in an apparatus selected from the group consisting of: a laptop computer, a smartphone, a tablet, a portable electronic device, a vehicular audio system.

In some embodiments, an apparatus may include a laser microphone comprising: (a) a laser transmitter to transmit an outgoing laser beam towards a human speaker; (b) a self-mix interferometry unit to receive an optical feedback signal reflected from the face of the human speaker, and to generate an optical self-mix signal by self-mixing interferometry of the laser power and the received optical feedback signal; wherein the laser microphone comprises at least a front-side minor and a rear-side minor, wherein the front-side mirror of the laser microphone has a first number of Distributed Bragg Reflector (DBR) layers; wherein the rear-side minor of the laser microphone has a second, different, number of Distributed Bragg Reflector (DBR) layers.

In some embodiments, the number of DBR layers of the rear-side minor, is greater by at least 1 percent relative to the number of DBR layers of the front-side minor.

In some embodiments, the number of DBR layers of the rear-side minor, is greater by at least 5 percent relative to the number of DBR layers of the front-side minor.

In some embodiments, the number of DBR layers of the rear-side minor, is greater by at least 10 percent relative to the number of DBR layers of the front-side minor.

In some embodiments, the number of DBR layers of the rear-side minor, is greater by at least 25 percent relative to the number of DBR layers of the front-side minor.

In some embodiments, the number of DBR layers of the rear-side minor, is smaller by at least 1 percent relative to the number of DBR layers of the front-side minor.

In some embodiments, the number of DBR layers of the rear-side minor, is smaller by at least 5 percent relative to the number of DBR layers of the front-side minor.

In some embodiments, the number of DBR layers of the rear-side minor, is smaller by at least 10 percent relative to the number of DBR layers of the front-side minor.

In some embodiments, the number of DBR layers of the rear-side minor, is smaller by at least 25 percent relative to the number of DBR layers of the front-side minor.

In some embodiments, a difference between (i) the number of DBR layers of the rear-side minor and (ii) the number of DBR layers of the front-side minor, increases at least one of: efficiency, usefulness, magnitude, bandwidth, signal-to-noise ratio, of said self-mixing interferometry performed by said self-mix interferometry unit.

In some embodiments, a difference between (i) the number of DBR layers of the rear-side minor and (ii) the number of DBR layers of the front-side minor, reduced a strength of said outgoing laser beam and also increases at least one of: efficiency, usefulness, magnitude, bandwidth, signal-to-noise ratio, of said self-mixing interferometry performed by said self-mix interferometry unit.

In some embodiments, the apparatus further comprises at least one acoustic microphone; wherein the apparatus is a hybrid acoustic-and-optical sensor.

In some embodiments, the apparatus further comprises at least one acoustic microphone; wherein the apparatus is a hybrid acoustic-and-optical sensor which is comprised in a device selected from the group consisting of: a laptop computer, a smartphone, a tablet, a portable electronic device, a vehicular audio system.

The present invention may include, for example, a laser microphone, laser-based microphone, and optical microphone utilizing minors having different properties. For example, a laser microphone includes at least two minors: a front-side mirror, and a rear-side minor. The reflectivity of the front-side minor, is different from the reflectivity of the rear-side minor; thereby increasing the efficiency or the accuracy of self-mixing of signals in the laser microphone. Additionally or alternatively, the front-side minor has a first number of Distributed Bragg Reflector (DBR) layers; and the rear-side minor has a second, different, number of DBR layers; thereby increasing the efficiency or the accuracy of self-mixing of signals in the laser microphone.

It is noted that some embodiments of the present invention may utilize the particular values, reflectivity values, ratios, differences, smaller-than differences, greater-than differences, ranges of values, or other specific values that are described above; and this are not merely arbitrary values, but rather, they may include particular values that may be particularly advantageous for improving the self-mix signal, in certain implementations. Additionally or alternatively, other suitable values, ratios, and/or ranges may be used in conjunction with the present invention.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

1. A system comprising:
a laser microphone comprising:
(a) a laser transmitter to transmit an outgoing laser beam towards a human speaker;
(b) a self-mix interferometry unit to receive an optical feedback signal reflected from the face of the human speaker, and to generate an optical self-mix signal by self-mixing interferometry of the laser power and the received optical feedback signal;
wherein the laser microphone comprises at least a front-side mirror and a rear-side minor,
wherein the front-side minor of the laser microphone has a first reflectivity,
wherein the rear-side minor of the laser microphone has a second, different, reflectivity.

2. The system of claim 1, wherein one of said rear-side minor and said front-side minor of the laser microphone has reflectivity of 99.9 percent; wherein the other one of said rear-side minor and said front-side minor of the laser microphone has reflectivity of not more than 99.8 percent.

3. The system of claim 1, wherein one of said rear-side minor and said front-side minor of the laser microphone has reflectivity of 99.9 percent; wherein the front-side mirror of the laser microphone has reflectivity of not more than 99.7 percent.

4. The system of claim 1, wherein one of said rear-side mirror and said front-side mirror of the laser microphone has reflectivity of 99.9 percent; wherein the other one of said rear-side mirror and said front-side mirror of the laser microphone has reflectivity of not more than 99.5 percent.

5. The system of claim 1, wherein one of said rear-side mirror and said front-side mirror of the laser microphone has reflectivity of 99.8 percent; wherein the other one of said rear-side mirror and said front-side mirror of the laser microphone has reflectivity of not more than 99.7 percent.

6. The system of claim 1, wherein one of said rear-side mirror and said front-side mirror of the laser microphone has reflectivity of 99.0 percent; wherein the other one of said rear-side mirror and said front-side mirror of the laser microphone has reflectivity of not more than 98.0 percent.

7. The system of claim 1, wherein reflectivity of the front-side mirror is at least 0.1 percent smaller than reflectivity of the rear-side mirror.

8. The system of claim 1, wherein reflectivity of the front-side mirror is at least 0.25 percent smaller than reflectivity of the rear-side mirror.

9. The system of claim 1, wherein reflectivity of the front-side mirror is at least 0.50 percent smaller than reflectivity of the rear-side mirror.

10. The system of claim 1, wherein reflectivity of the front-side mirror is at least 1.0 percent smaller than reflectivity of the rear-side mirror.

11. The system of claim 1, wherein reflectivity of the front-side mirror is at least 2.0 percent smaller than reflectivity of the rear-side mirror.

12. The system of claim 1, wherein reflectivity of the front-side minor is at least 5.0 percent smaller than reflectivity of the rear-side mirror.

13. The system of claim 1, wherein reflectivity of the front-side minor is at least 10.0 percent smaller than reflectivity of the rear-side mirror.

14. The system of claim 1, wherein reflectivity of the front-side minor is at least 0.25 percent greater than reflectivity of the rear-side mirror.

15. The system of claim 1, wherein reflectivity of the front-side minor is at least 0.50 percent greater than reflectivity of the rear-side mirror.

16. The system of claim 1, wherein reflectivity of the front-side minor is at least 1.0 percent greater than reflectivity of the rear-side mirror.

17. The system of claim 1, wherein reflectivity of the front-side minor is at least 2.0 percent greater than reflectivity of the rear-side mirror.

18. The system of claim 1, wherein reflectivity of the front-side minor is at least 5.0 percent greater than reflectivity of the rear-side mirror.

19. The system of claim 1, wherein reflectivity of the front-side minor is at least 10.0 percent greater than reflectivity of the rear-side mirror.

20. The system of claim 1, wherein one of said rear-side mirror and said front-side minor of the laser microphone has a first reflectivity in a range of 28 to 33 percent;
wherein the other one of said rear-side mirror and said front-side mirror of the laser microphone has a second, different, reflectivity that is at least 1 percent smaller than said first reflectivity.

21. The system of claim 1, wherein one of said rear-side minor and said front-side minor of the laser microphone has reflectivity in a range of 25 to 35 percent;
wherein the other one of said rear-side mirror and said front-side minor of the laser microphone has a second, different, reflectivity that is at least 1 percent smaller than said first reflectivity.

22. The system of claim 1, wherein the front-side minor of the laser microphone has a first number of Distributed Bragg Reflector (DBR) layers; wherein the rear-side minor of the laser microphone has a second, greater, number of Distributed Bragg Reflector (DBR) layers.

23. The system of claim 1, wherein the front-side minor of the laser microphone has a first number of Distributed Bragg Reflector (DBR) layers; wherein the rear-side minor of the laser microphone has a second number of Distributed Bragg Reflector (DBR) layers which is greater than the first number of DBR layers by at least 1 percent.

24. The system of claim 1, wherein the front-side minor of the laser microphone has a first number of Distributed Bragg Reflector (DBR) layers; wherein the rear-side minor of the laser microphone has a second number of Distributed Bragg Reflector (DBR) layers which is greater than the first number of DBR layers by at least 2 percent.

25. The system of claim 1, wherein the front-side mirror of the laser microphone has a first number of Distributed Bragg Reflector (DBR) layers; wherein the rear-side minor of the laser microphone has a second number of Distributed Bragg Reflector (DBR) layers which is greater than the first number of DBR layers by at least 5 percent.

26. The system of claim 1, wherein the front-side mirror of the laser microphone has a first number of Distributed Bragg Reflector (DBR) layers; wherein the rear-side minor of the laser microphone has a second number of Distributed Bragg Reflector (DBR) layers which is smaller than the first number of DBR layers by at least 1 percent.

27. The system of claim 1, wherein the front-side minor of the laser microphone has a first number of Distributed Bragg Reflector (DBR) layers; wherein the rear-side minor of the laser microphone has a second number of Distributed Bragg Reflector (DBR) layers which is smaller than the first number of DBR layers by at least 2 percent.

28. The system of claim 1, wherein the front-side minor of the laser microphone has a first number of Distributed Bragg Reflector (DBR) layers; wherein the rear-side minor of the laser microphone has a second number of Distributed Bragg Reflector (DBR) layers which is smaller than the first number of DBR layers by at least 5 percent.

29. The system of claim 1, wherein a difference between (i) the reflectivity of the front-side minor and (ii) the reflectivity of the rear-side minor, increases at least one of:
efficiency, usefulness, magnitude, bandwidth, signal-to-noise ratio, of said self-mixing interferometry performed by said self-mix interferometry unit.

30. The system of claim 1, wherein a difference between (i) the first reflective value of the front-side mirror and (ii) the second reflective value of the rear-side mirror, reduces a strength of said outgoing laser beam and also increases at least one of:
efficiency, usefulness, magnitude, bandwidth, signal-to-noise ratio, of said self-mixing interferometry performed by said self-mix interferometry unit.

31. The system of claim 1, further comprising at least one acoustic microphone; wherein the system is a hybrid acoustic-and-optical sensor.

32. The system of claim 1, further comprising at least one acoustic microphone; wherein the system is a hybrid acoustic-and-optical sensor which is comprised in an apparatus selected from the group consisting of: a laptop computer, a smartphone, a tablet, a portable electronic device, a vehicular audio system.

33. An apparatus comprising:
a laser microphone comprising:
(a) a laser transmitter to transmit an outgoing laser beam towards a human speaker;
(b) a self-mix interferometry unit to receive an optical feedback signal reflected from the face of the human speaker, and to generate an optical self-mix signal by self-mixing interferometry of the laser power and the received optical feedback signal;
wherein the laser microphone comprises at least a front-side mirror and a rear-side minor,
wherein the front-side minor of the laser microphone has a first number of Distributed Bragg Reflector (DBR) layers; wherein the rear-side minor of the laser microphone has a second, different, number of Distributed Bragg Reflector (DBR) layers.

34. The apparatus of claim 33, wherein the number of DBR layers of the rear-side minor, is greater by at least 1 percent relative to the number of DBR layers of the front-side minor.

35. The apparatus of claim 33, wherein the number of DBR layers of the rear-side minor, is greater by at least 5 percent relative to the number of DBR layers of the front-side minor.

36. The apparatus of claim 33, wherein the number of DBR layers of the rear-side mirror, is greater by at least 10 percent relative to the number of DBR layers of the front-side minor.

37. The apparatus of claim 33, wherein the number of DBR layers of the rear-side mirror, is greater by at least 25 percent relative to the number of DBR layers of the front-side minor.

38. The apparatus of claim 33, wherein the number of DBR layers of the rear-side minor, is smaller by at least 1 percent relative to the number of DBR layers of the front-side minor.

39. The apparatus of claim 33, wherein the number of DBR layers of the rear-side minor, is smaller by at least 5 percent relative to the number of DBR layers of the front-side minor.

40. The apparatus of claim 33, wherein the number of DBR layers of the rear-side minor, is smaller by at least 10 percent relative to the number of DBR layers of the front-side minor.

41. The apparatus of claim 33, wherein the number of DBR layers of the rear-side mirror, is smaller by at least 25 percent relative to the number of DBR layers of the front-side minor.

42. The apparatus of claim 33, wherein a difference between (i) the number of DBR layers of the rear-side mirror and (ii) the number of DBR layers of the front-side mirror, increases at least one of: efficiency, usefulness, magnitude, bandwidth, signal-to-noise ratio, of said self-mixing interferometry performed by said self-mix interferometry unit.

43. The apparatus of claim 33, wherein a difference between (i) the number of DBR layers of the rear-side mirror and (ii) the number of DBR layers of the front-side mirror, reduces a strength of said outgoing laser beam and also increases at least one of: efficiency, usefulness, magnitude, bandwidth, signal-to-noise ratio, of said self-mixing interferometry performed by said self-mix interferometry unit.

44. The apparatus of claim 33, further comprising at least one acoustic microphone; wherein the apparatus is a hybrid acoustic-and-optical sensor.

45. The apparatus of claim 33, further comprising at least one acoustic microphone; wherein the apparatus is a hybrid acoustic-and-optical sensor which is comprised in a device selected from the group consisting of: a laptop computer, a smartphone, a tablet, a portable electronic device, a vehicular audio system.
